(19) United States
(12) Patent Application Publication
(10) Pub. No.: US 2015/0277700 A1
(43) Pub. Date: Oct. 1, 2015

(54) SYSTEM AND METHOD FOR PROVIDING GRAPHICAL USER INTERFACE

(71) Applicant: USENS, INC., San Jose, CA (US)

(72) Inventor: Anli HE, San Jose, CA (US)

(73) Assignee: USENS, INC.

(21) Appl. No.: 14/741,038

(22) Filed: Jun. 16, 2015

Related U.S. Application Data
(63) Continuation-in-part of application No. 14/462,324, filed on Aug. 18, 2014.
Application No. 14/462,324 is a continuation-in-part of application No. 14/034,286, filed on Sep. 23, 2013.
(60) Provisional application No. 62/013,485, filed on Jun. 17, 2014.
(60) Provisional application No. 61/869,726, filed on Aug. 25, 2013.
(60) Provisional application No. 61/841,864, filed on Jul. 1, 2013.
(60) Provisional application No. 61/811,680, filed on Apr. 12, 2013.

(51) Int. Cl. G06F 3/0481; G06F 3/0346; G06F 3/01; G06F 3/0484; G06F 3/0487

(52) U.S. Cl. CPC G06F 3/04815; G06F 3/04842; G06F 3/0487; G06F 3/017; G06F 3/0346; G06F 2203/04802; G06F 2203/04806

(57) ABSTRACT

A system for providing a graphical user interface is provided. The system includes a display, at least one imaging sensor configured to capture at least one image associated with a user, one or more processors, and a memory for storing instructions executable by the one or more processors. The one or more processors may be configured to detect a gesture of a target part of the user based on the at least one image, and determine, based on the gesture of the target part of the user, three-dimensional (3D) coordinates of at least one 3D object in a 3D coordinate system. The one or more processors may be further configured to perform a projection of the at least one 3D object onto the display based on the 3D coordinates and render the at least one 3D object on the display according to the projection.

### CROSS REFERENCE TO RELATED APPLICATIONS

This application is a continuation-in-part application of application Ser. No. 14/462,324, titled “Interactive Input System and Method,” filed Aug. 18, 2014, which is a continuation-in-part application of application Ser. No. 14/034,286, titled “Interactive Input System and Method,” filed Sep. 23, 2013, which is based upon and claims the benefit of priority from Provisional Application No. 61/811,680, titled “3D and 2D Interactive Input System and Method,” filed on Apr. 12, 2013, and Provisional Application No. 61/841,864, titled “3D and 2D Interactive Input System and Method,” filed on Jul. 1, 2013. Application Ser. No. 14/462,324 is also based upon and claims the benefit of priority from Provisional Application No. 61/869,726, titled “3D and 2D Interactive Input System and Method,” filed on Aug. 25, 2013. This application is also based upon and claims the benefit of priority from Provisional Application No. 62/013,485, titled “User Interface and Interaction with Hand Tracking and Head Tracking,” filed on Jun. 17, 2014. The entire contents of all of the above-referenced applications are incorporated herein by reference.

### TECHNOLOGY FIELD

The disclosure relates to graphical user interfaces and, more particularly, to systems and methods for providing graphical user interfaces for three-dimensional (3D) objects.

### BACKGROUND

Existing technology for enhancing the realisms and naturalness of the graphical user interface (GUI) often includes adding three-dimensional (3D) hints into the graphics rendering of the GUI, such as reflection effect, drop shadow effect, etc. However, these 3D hints do not render a perception of a 3D scene in a virtual 3D space surrounding a user, and thus are often found unsatisfactory for providing a realistic feeling of the GUI.

Moreover, when a two-dimensional (2D) display device is used to display 3D objects, existing 3D hand input devices are not capable to provide an intuitive user interface that allows a user to control or interact with the virtual 3D objects displayed on the 2D display in a natural and direct manner.

Therefore, there is a need for a graphical user interface that provides realistic depiction of a 3D scene and also allows a user to interact with displayed 3D objects in a natural way.

### SUMMARY

The present disclosure provides a system for providing a graphical user interface. Consistent with some embodiments, the system includes a display, at least one imaging sensor configured to capture at least one image associated with a user, one or more processors, and a memory for storing instructions executable by the one or more processors. The one or more processors may be configured to detect a gesture of a target part of the user based on the at least one image, and determine, based on the gesture of the target part of the user, 3D coordinates of at least one 3D object in a 3D coordinate system. The 3D coordinate system may be associated with a virtual 3D space perceived by the user. The one or more processors may be further configured to perform a projection of the at least one 3D object onto the display based on the 3D coordinates and render the at least one 3D object on the display according to the projection.

Consistent with some embodiments, this disclosure provides a method for providing a graphical user interface. The method includes detecting a gesture of a target part of a user based on at least one image associated with the user, and determining, based on the gesture of the target part of the user, 3D coordinates of at least one 3D object in a 3D coordinate system. The 3D coordinate system may be associated with a virtual 3D space perceived by the user. The method may further include performing a projection of the at least one 3D object onto a display based on the 3D coordinates and rendering the at least one 3D object on the display according to the projection.

Consistent with some embodiments, this disclosure provides a non-transitory computer-readable storage medium storing program instructions executable by one or more processors to perform a method for providing a graphical user interface. The method includes detecting a gesture of a target part of a user based on at least one image associated with the user, and determining, based on the gesture of the target part of the user, 3D coordinates of at least one 3D object in a 3D coordinate system. The 3D coordinate system may be associated with a virtual 3D space perceived by the user. The method may further include performing a projection of the at least one 3D object onto a display based on the 3D coordinates and rendering the at least one 3D object on the display according to the projection.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an exemplary interactive system, in accordance with an embodiment of the present disclosure.

FIG. 2 illustrates an exemplary arrangement of a sensing device, in accordance with an embodiment of the present disclosure.

FIG. 3 illustrates another exemplary arrangement of a sensing device, in accordance with an embodiment of the present disclosure.

FIG. 4 illustrates an exemplary arrangement of multiple sensing devices, in accordance with an embodiment of the present disclosure.

FIGS. 5A-5C illustrate exemplary implementations of a sensing device, in accordance with embodiments of the present disclosure.

FIG. 6 illustrates an exemplary diagram of a user gesture tracking process, in accordance with an embodiment of the present disclosure.

FIG. 7 illustrates another exemplary diagram of a user gesture tracking process, in accordance with an embodiment of the present disclosure.

FIG. 8 illustrates another exemplary diagram of a user gesture tracking process, in accordance with an embodiment of the present disclosure.

FIG. 9 illustrates an exemplary diagram of a 3D user interface, in accordance with an embodiment of the present disclosure.

FIG. 10 illustrates an exemplary diagram of coordinate systems of a 3D user interface and a sensing device, in accordance with an embodiment of the present disclosure.

FIG. 11 schematically shows a user's head pose in a coordinate system of a sensing device, according to an exemplary embodiment.

FIG. 12 schematically shows a user's hand gesture in a coordinate system of a sensing device, according to an exemplary embodiment.

FIG. 13 illustrates an exemplary diagram of a rendering result, in accordance with an embodiment of the present disclosure.

FIG. 14 illustrates an exemplary diagram of a perception of 3D objects in a virtual 3D space, in accordance with an embodiment of the present disclosure.

FIG. 15 illustrates another exemplary diagram of a rendering result, in accordance with an embodiment of the present disclosure.

FIG. 16 illustrates another exemplary diagram of a perception of 3D objects in a virtual 3D space, in accordance with an embodiment of the present disclosure.

FIG. 17 illustrates an exemplary diagram of a user interaction with a 3D object rendered on a display, in accordance with an embodiment of the present disclosure.

FIG. 18 illustrates an exemplary diagram of a user interaction with a 3D object in a virtual 3D space, in accordance with an embodiment of the present disclosure.

FIG. 19 illustrates another exemplary diagram of a user interaction with a 3D object rendered on a display, in accordance with an embodiment of the present disclosure.

FIG. 20 illustrates another exemplary diagram of a user interaction with a 3D object in a virtual 3D space, in accordance with an embodiment of the present disclosure.

FIG. 21 illustrates an exemplary diagram of 3D objects rendered in a display and in a virtual 3D space respectively, in accordance with an embodiment of the present disclosure.

FIG. 22 illustrates another exemplary diagram of 3D objects rendered in a display and in a virtual 3D space respectively, in accordance with an embodiment of the present disclosure.

FIG. 23 illustrates another exemplary diagram of 3D objects rendered in a display and in a virtual 3D space respectively, in accordance with an embodiment of the present disclosure.

FIG. 24 illustrates another exemplary diagram of 3D objects rendered in a display and in a virtual 3D space respectively, in accordance with an embodiment of the present disclosure.

FIG. 25 is a flowchart of an exemplary method for providing a graphical user interface, in accordance with an embodiment of the present disclosure.

### DESCRIPTION OF THE EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. It is intended that the following detailed description be considered as exemplary only, with the true scope and spirit being indicated by the following claims.

The illustrated components and steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

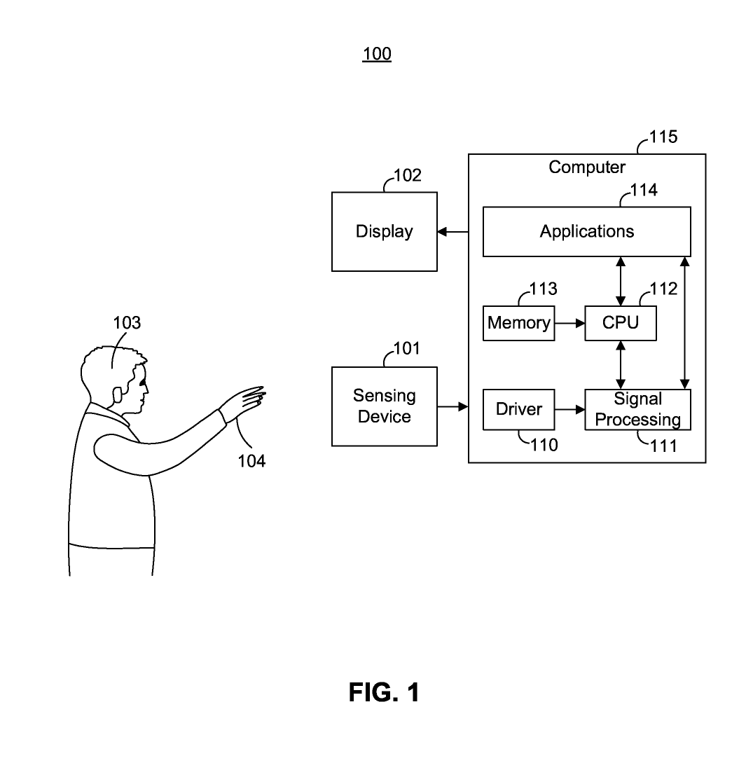

FIG. 1 illustrates an exemplary interactive system 100, in accordance with an embodiment of the present disclosure. As shown in FIG. 1, the interactive system 100 includes a sensing device 101, a display 102, and a computer 115. The computer 115 may include a Central Processing Unit (CPU) 112, a memory 113, one or more applications 114, a driver 110, and signal processing module 111.

The sensing device 101 is configured to sense a user gesture and transfer the detected user gesture to the computer 115, for example, via the driver 110 installed on the computer 115. The user gesture may be, for example, a gesture made by a head 103 of a user and/or a hand 104 of a user. The user gesture may be made in the air without any physical contact with the computer 115, the sensing device 101, or the display 102. In some embodiments, the sensing device 101 may include one or more imaging sensors configured to capture images of the user. The output provided by the sensing device 101 may include, for example, images depicting gestures of a target part of the user, for example, the head 103 and/or the hand 104 of the user. The sensing device 101 may be connected to the computer 115 through a wired connection, such as a Universal Serial Bus (USB) connection, or through a wireless connection, such as Wi-Fi, Bluetooth, etc. In some embodiments, the sensing device 101 may be implemented as an integrated part of the computer 115 or as an integrated part of the display 102. In other embodiments, the sensing device 101 may be implemented as a standalone external device with an interface to connect to the computer 115.

Consistent with embodiments of the disclosure, the sensing device 101 may include one or more imaging sensors, such as cameras. The imaging sensors may be visible light imaging sensors which are more responsive to visible light, or infrared (IR) imaging sensors which are more responsive to IR light. The sensing device 101 may also include one or more illumination sources, which provide illumination in various wavelengths according to the type of the imaging sensors. The illumination sources may be, for example, light-emitting diodes (LED's) or lasers equipped with diffusers. In some embodiments, the illumination sources may be omitted and the imaging sensors detect the environmental light reflected by an object or the light emitted by an object.

In some embodiments, multiple sensing devices may be included in the interactive system 100. Each of the sensing devices may be configured to detect a gesture relating to a portion of a target part of the user. For example, the target part of the user may include the user's head and hand. Thus, one sensing device may be configured to detect a gesture of a user's head, and another sensing device may be configured to detect a gesture of a user's hand.

The sensing device driver 110 controls the operation of the sensing device 101. The sensing device driver 110 receives input, e.g., the images containing user gestures, from the sensing device 101, and outputs the received information of the user gestures to the signal processing module 111. The signal processing software 111 reads the output from driver 110, and processes such information to output the 3D tracking result of user's head, hand, and/or fingers. In some embodiments, the output of the signal processing module 111 may include the 3D position, orientation, or moving direction of a target part of the user including, for example, user's head, fingers, hand palm, and/or hand. The signal processing module 111 may implement various tracking head and hand tracking methods, such as active shape method and/or active appear method for heading tracking, image database search method, feature recognition and tracking method, contour analysis method for hand tracking, and the like. The signal processing module 111 may also implement other detection and tracking methods known to persons skilled in the relevant art(s), which are not described in the present disclosure.

The applications 114 receives 3D tracking result of user's head, hand, and/or fingers, updates the internal state and graphical user interface (GUI), and renders the resulting graphics to the display 102. For example, the applications 114 may store programs for determining 3D coordinates of 3D objects in a virtual 3D space around the user based on the tracking result of a target part of a user. As another example, the applications 114 may store programs for projecting 3D objects onto the display 102 such that the user perceives the 3D objects at certain positions in a virtual 3D space surrounding the user. The display 102 may receive audio and/or visual signals from the computer 115 and output the audio and/or visual signals to the user. The display 102 may be connected to the computer 115 via, for example, an S-Video cable, a coaxial cable, an HDMI cable, a DVI cable, a VGA cable, or the like. The display 102 may be configured to display 3D objects and produce a 3D effect as a user looks into the display screen. The display 102 may also be configured to display 2D images in a 2D plane.

The CPU 112 may include one or more processors and may be configured to execute instructions associated with operations of the computer 115. Additionally, the CPU 112 may execute certain instructions and commands stored in the memory 113, and/or the applications 114, to provide a graphical user interface, for example, via the display 102. The CPU 112 may include a microprocessor, such as AMD Athlon, Duron or Opteron, ARM's application, embedded or secure processors, IBM PowerPC, Intel's Core, Itanium, Xeon, Celeron or other line of processors, etc. The CPU 112 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

The memory 113 may store a collection of program or database components, including, without limitation, an operating system, one or more applications 114, user/application data (e.g., any data representing user gestures or data representing coordinates of 3D objects discussed in this disclosure), etc. Operating system may facilitate resource management and operation of the computer 115. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

The computer 115 may also include other auxiliary components, such as an input/output (I/O) interface for communicating with the sensing device 101, the display 102, or other I/O devices. The I/O interface may employ communication protocols/methods such as, without limitation, audio, analog, digital, monoaural, RCA, stereo, IEEE-1394, serial bus, USB, infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc. The computer 115 may also include random access memory (RAM), read only memory (ROM), secondary storage (for example, a hard disk drive or flash memory), and so on. One skilled in the art will readily appreciate that various other components can also be included in the computer 115.

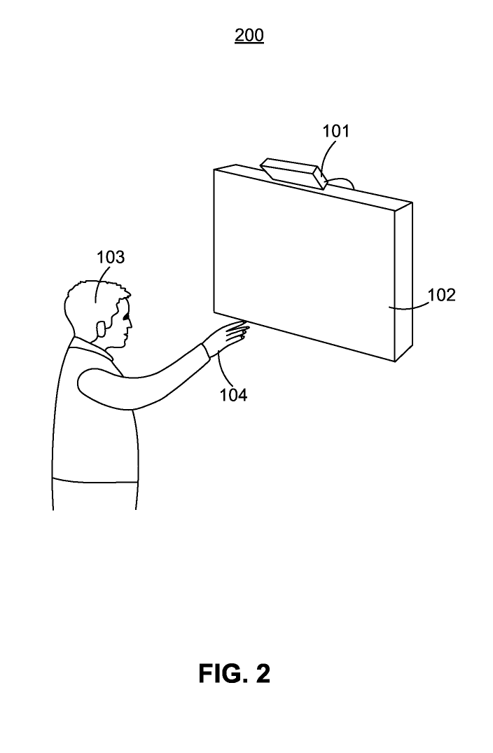

FIG. 2 illustrates an exemplary arrangement 200 of a sensing device, in accordance with an embodiment of the present disclosure. As shown in FIG. 2, the sensing device 101 is placed on top of the display 102 in a direction facing the user, where the user is located in front of the display 102. The sensing device 101 may be configured to capture images containing the user's head 103 and/or the user's hand 104. As illustrated in FIG. 2, the front side of the sensing device 101 may form an angle that is between 90 degrees and 180 degrees with respect to the vertical plane of the display 102.

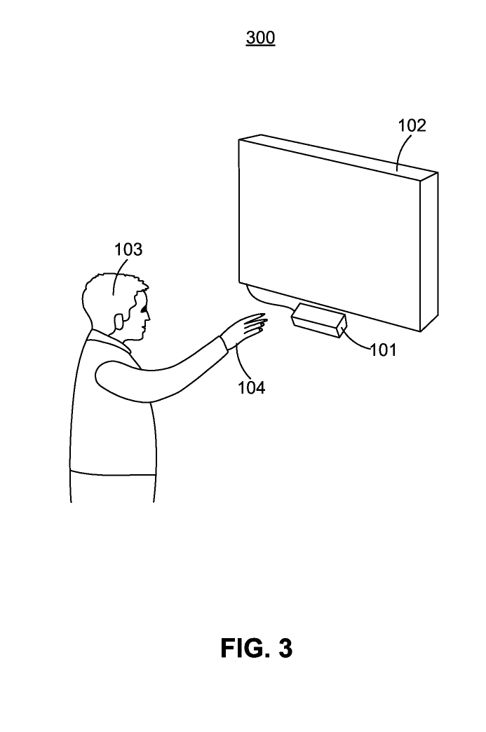

FIG. 3 illustrates another exemplary arrangement 300 of a sensing device, in accordance with an embodiment of the present disclosure. As shown in FIG. 3, the sensing device 101 is placed near the bottom of the display 102 in a direction facing the user, where the user is located in front of the display 102. The sensing device 101 may be configured to capture images containing the user's head 103 and/or the user's hand 104. For example, the sensing device 101 may be placed on a surface of a tabletop which is used to hold the display 102. As illustrated in FIG. 3, the front side of the sensing device 101 may form a downward angle respect to the horizontal plane of the display 102.

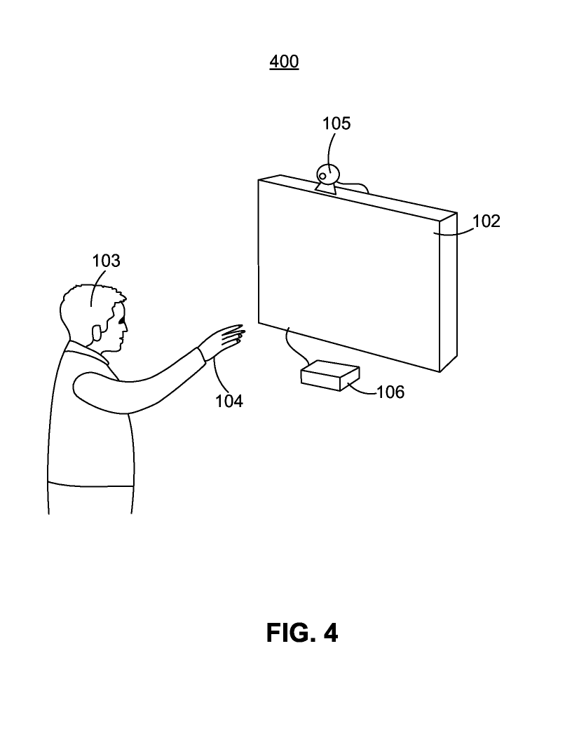

FIG. 4 illustrates an exemplary arrangement 400 of multiple sensing devices, in accordance with an embodiment of the present disclosure. As shown in FIG. 4, two sensing devices 105 and 106 are present in the interactive system, where the sensing device 105 is placed on top of the display 102 in a direction facing the user, and the sensing device 106 is placed near the bottom of the display 102 in a face-up direction. The user is located in front of the display 102. The sensing devices 105 and 106 may have a similar structure and functionality as that of the sensing device 101 described in the present disclosure. For example, the sensing device 105 may be configured to track the gesture of user's head 103, and the sensing device 106 may be configured to track the gesture of user's hand 104. In some embodiments, more than two sensing devices may be used in the interactive system to track gestures of the user by different body parts. For example, a first sensing device may be placed on top of the display to track the gesture of user's head 103, a second sensing device may be placed on the left side near the bottom of the display to track the gesture of user's left hand, and a third sensing device may be placed on the right side near the bottom of the display to track the gesture of user's right hand.

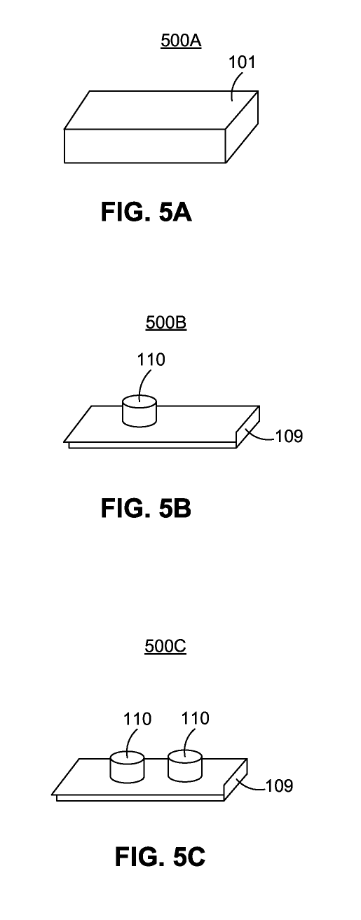

FIGS. 5A-5C illustrate exemplary implementations 500A-500C of a sensing device, in accordance with embodiments of the present disclosure. As shown in FIG. 5A, the sensing device 101 may be a stand-alone device separated from the computer 115 but can be coupled to the computer 115 via a wired connection (such as a USB cable) or a wireless connection (such as Bluetooth or WiFi).

In some embodiments, the sensing device 101 may be integrated into the computer 115, i.e., may be part of the computer 115. As shown in FIG. 5B, the sensing device 101 may include a single imaging sensor 110, where the imaging sensor 110 is coupled to a system board 109. The system board 109 may be configured to control the imaging sensor 110, process the captured image, and transfer the processing result to other components of the computer 115. The imaging sensor 110 may include a 2D gray scale or color image sensor, a time-of-flight sensor, a structured light projector and 2D gray scale sensor, or any other types of sensor systems known to one skilled in the related art.

In some embodiments, the sensing device 101 may include multiple imaging sensors. As shown in FIG. 5C, the sensing device 101 includes two imaging sensors 110, where the imaging sensors 110 are coupled to the system board 109. The imaging sensors 110 may include stereo gray scale cameras and uniform IR LED lighting, stereo gray scale cameras and structured light projection, or any other types of imaging systems known to one skilled in the related art. While FIG. 5C shows two imaging sensors, the sensing device 101 may include more than two imaging sensors without departing from the scope and spirit of the present disclosure.

The sensing device 101 may be configured to capture images containing a target part of the user, such as the user's hand and head, and provide the captured images to the computer 115. The computer 115 may detect the gesture of the user based on the captured images and adjust the rendering of a 3D scene to provide a natural representation to the user.

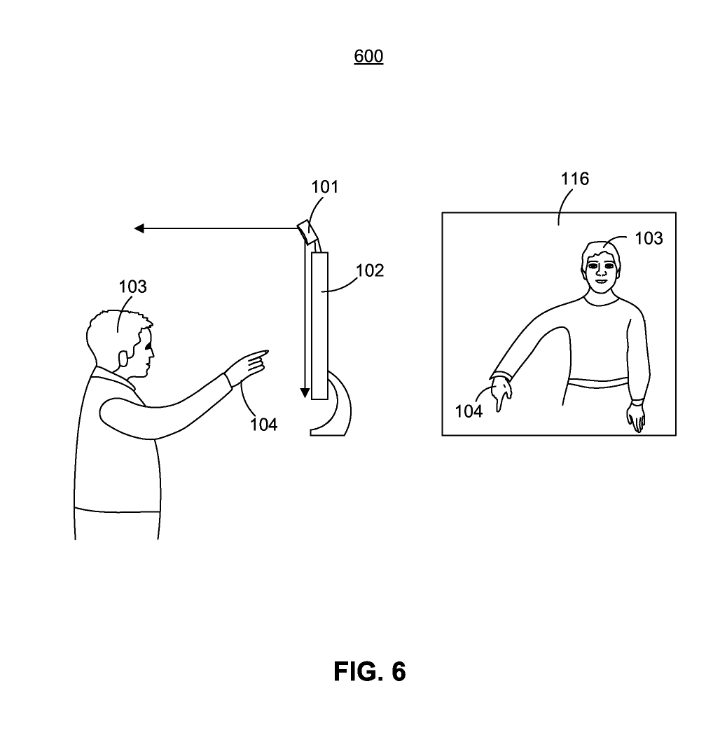

FIG. 6 illustrates an exemplary diagram 600 of a user gesture tracking process, in accordance with an embodiment of the present disclosure. As shown in FIG. 6, a single sensing device 101 is placed on top of display 102, in an orientation facing towards the user, such that the coverage area of the sensing device 101 includes the user's head 103 and hand 104. An image 116 containing user's head 103 and user's hand 104 is captured by the sensing device 101. Subsequently, the sensing device 101 may output the captured image 116 to the computer 115 for processing.

For example, the computer 115 may implement head detection and tracking methods to detect user's head 103 in the image 116 and obtain information of the pose of the user's head 103. In some embodiments, the information of the gesture of the user's head 103 may include both 3D position and 3D orientation of the user's head, providing 6 degree of freedom (DOF) information of head's gesture. The head tracking methods may include the active shape method, the active appear method, or other head tracking methods known to persons skilled in the relevant art.

The computer 115 may also implement hand detection and tracking methods to detect user's hand 104 in the image 116 and obtain information of the gesture of the user's hand 104. In some embodiments, the information of the gesture of the user's hand 104 may include both 3D position and 3D orientation of the user's hand, providing 6 DOF information of the hand's gesture. Further, the information of the gesture of the user's hand 104 may include both 3D position and 3D orientation of each finger, providing 6 DOF information of each finger. Thus, a total of 36 degree of freedom information may be obtained for the user's hand 104. The hand tracking methods may include the image database search method, the feature recognition and tracking method, contour analysis method, or other hand tracking methods known to persons skilled in the relevant art.

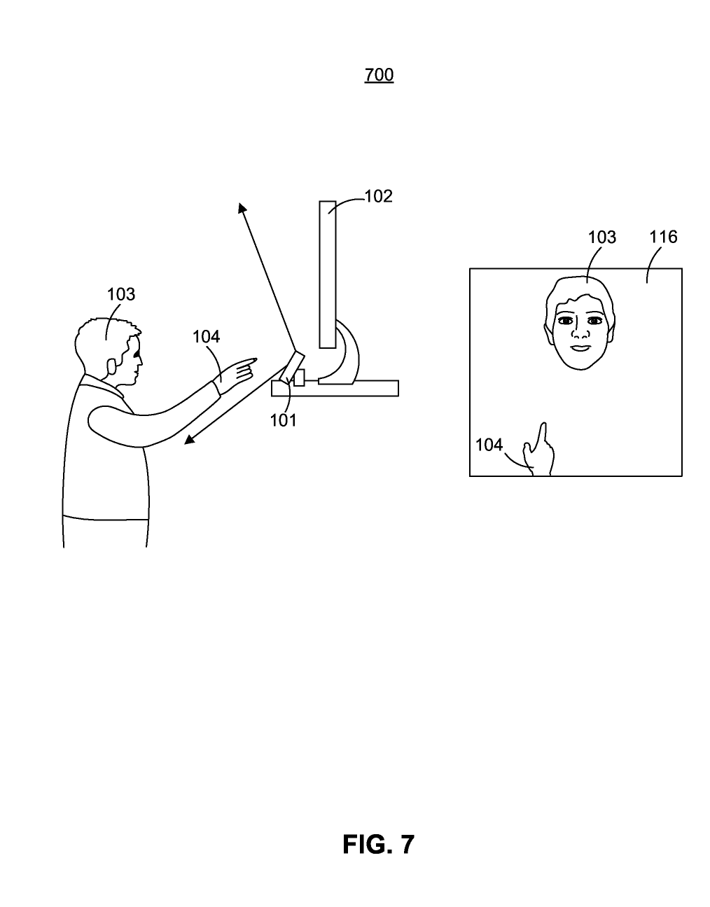

FIG. 7 illustrates another exemplary diagram 700 of a user gesture tracking process, in accordance with an embodiment of the present disclosure. As shown in FIG. 7, a single sensing device 101 is placed on a surface of a tabletop where the display 102 is placed, in an orientation facing towards the user, such that the coverage area of the sensing device 101 includes the user's head 103 and hand 104. An image 116 containing user's head 103 and user's hand 104 is captured by the sensing device 101. Subsequently, the sensing device 101 may output the captured image 116 to the computer 115 for processing and obtaining information of gestures of the user's head 103 and hand 104.

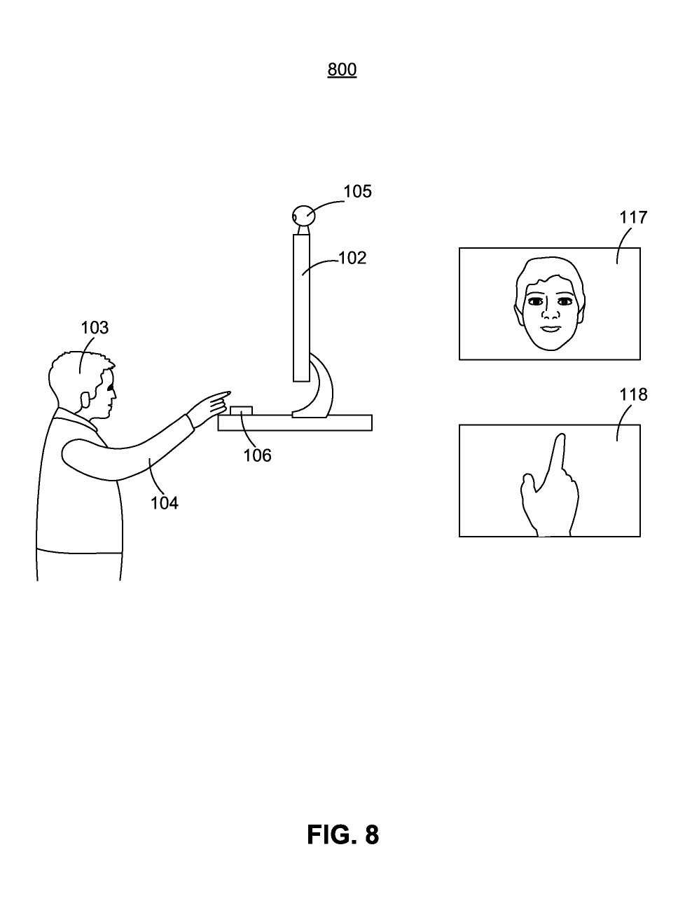

FIG. 8 illustrates another exemplary diagram 800 of a user gesture tracking process, in accordance with an embodiment of the present disclosure. As shown in FIG. 8, a sensing device 105 is placed on top of the display 102 in a direction facing the user to track the gesture of user's head 103, and another sensing device 106 is placed near the bottom of the display 102 in a face-up direction to track the gesture of user's hand 104. An image 117 containing user's head 103 is captured by the sensing device 105, and another image 118 containing user's hand 104 is captured by the sensing device 106. Subsequently, the sensing device 101 may output the captured images 117 and 118 to the computer 115 for processing and obtaining information of gestures of the user's head 103 and hand 104. For example, the computer 115 may apply head tracking algorithms on the image 117 to obtain 3D position and 3D orientation of the user's head 103, and apply hand tracking algorithms on the image 118 to obtain 3D position and 3D orientation of the user's hand 104.

After obtaining the information about the user's gesture, the computer 115 may convert the 3D position and 3D orientation of the user's hand and/or head into 3D coordinates of a virtual 3D space perceived by the user. The computer 115 may adjust the 3D rendering result accordingly to provide a user interface that suits the user's point of view.

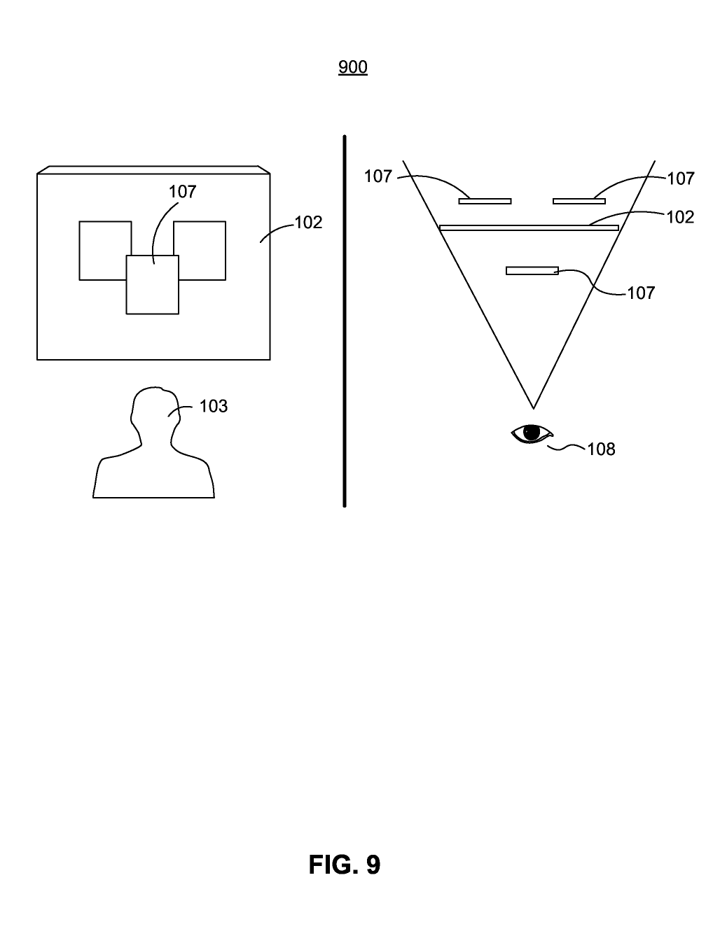

FIG. 9 illustrates an exemplary diagram 900 of a 3D user interface, in accordance with an embodiment of the present disclosure. The left side diagram shows that 3D objects 107 are rendered on the display 102 which is located in front of the user's head 103. The right side diagram shows that the 3D objects 107 are perceived by the user's eye 108 as being positioned in a virtual 3D space, in which the 3D objects 107 appear to have depth beyond and in front of the display 102. As illustrated in the right side diagram, two of the 3D objects 107 appear to be located farther away from the display 102, and one of the 3D objects 107 appear to be located closer than the display 102 in the virtual 3D space, producing a 3D user interface from the user's point of view.

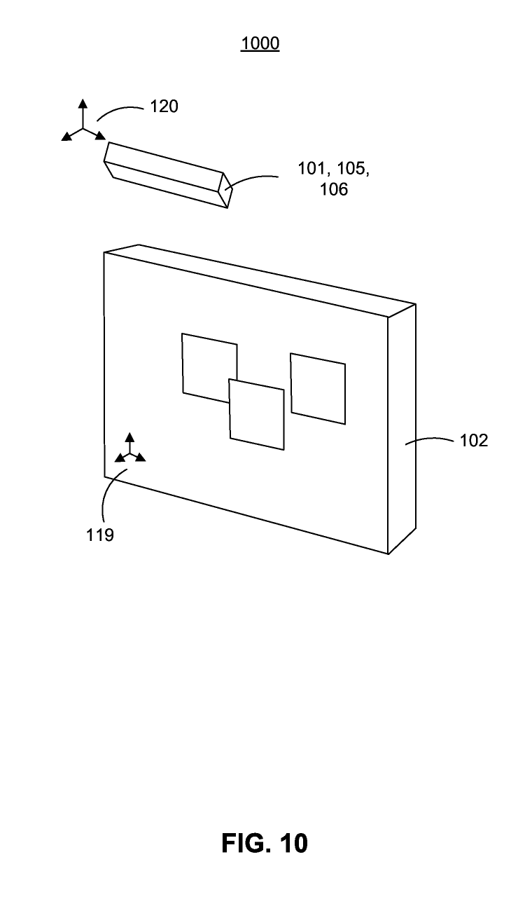

FIG. 10 illustrates an exemplary diagram 1000 of coordinate systems of a 3D user interface and a sensing device, in accordance with an embodiment of the present disclosure. As shown in FIG. 10, coordinate system 119 is associated with the virtual 3D space where items in a 3D scene are presented to the user, and coordinate system 120 is associated with the position of a sensing device, such as sensing devices 101, 105, and 106 described above. In this disclosure, the coordinate system 119 of the virtual 3D space is denoted as R_{w}, and the coordinate system 120 of the sensing device is denoted as R_{d}.

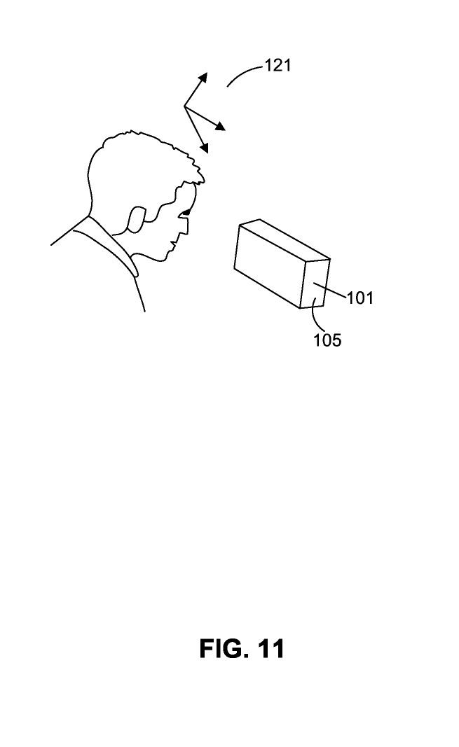

FIG. 11 schematically shows a user's head pose in a coordinate system of a sensing device, according to an exemplary embodiment. For example, the user's head pose may be described by the 3D position and 3D orientation 121 of the user's head in the coordinate system R_{d} associated with the sensing device 101 or 105. The 3D position and 3D orientation 121 of the user's head in the coordinate system R_{d} may be converted into a corresponding 3D position and 3D orientation in the coordinate system R_{w} associated with the virtual 3D space. The conversion may be performed based on the relation between the coordinate system R_{w} and the coordinate system R_{d}.

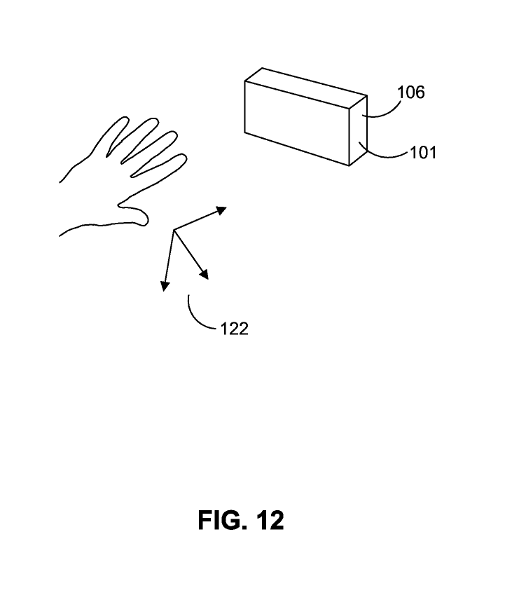

FIG. 12 schematically shows a user's hand gesture in a coordinate system of a sensing device, according to an exemplary embodiment. For example, the user's hand gesture may be described by the 3D position and 3D orientation 122 of the user's hand in the coordinate system R_{d} associated with the sensing device 101 or 106. The 3D position and 3D orientation 122 of the user's hand in the coordinate system R_{d} may be converted into a corresponding 3D position and 3D orientation in the coordinate system R_{w} associated with the virtual 3D space. The conversion may be performed based on the relation between the coordinate system R_{w} and the coordinate system R_{d}.

In some embodiments, the 3D position of the user's left eye and right eye may be determined based on the user's head 3D position and 3D orientation. When the display 102 is a stereo display, the computer 115 may use the user's left eye position to render the view for left eye, and use the user's right eye position to render the view for right eye. When the display 102 is a 2D display, the computer 115 may use the average of left eye position and right eye position to render the 3D scene.

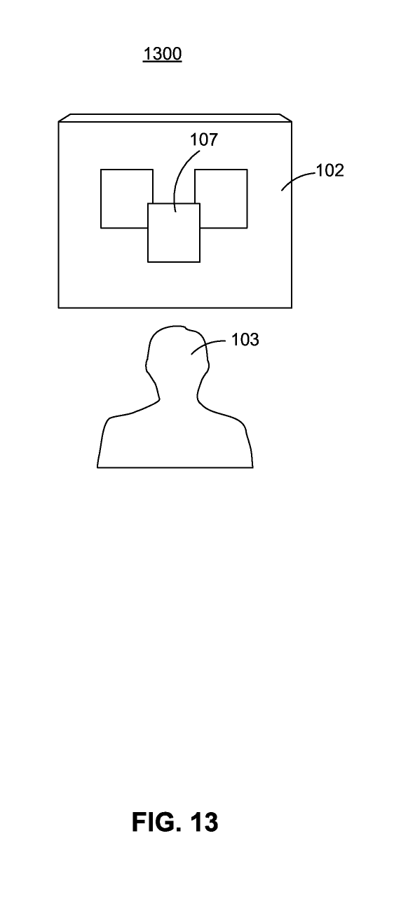

FIG. 13 illustrates an exemplary diagram 1300 of a rendering result, in accordance with an embodiment of the present disclosure. In this example, the user's head 103 is located in front of the center of the display 102, and as a result, the user's eye position is in front of the center of the display 102. In some embodiments, the 3D objects 107 may be rendered to the display 102 by taking account of the user's eye position. For example, when the relative position between the user's head 103 and the display 102 changes, the rendering result of the 3D objects 107 on the display 102 may change to provide a realistic 3D perception to the user. The 3D objects 107 may be rendered on the display 102 with 3D rendering effects such as shadowing, reflection, etc., and these 3D rendering effects may be adjusted based on the relative position between the user's head 103 and the display 102. In other words, the projection of the 3D objects 107 onto the display 102 may be performed based on the relative position between the user's head 103 and the display 102. Thus, when user's head 103 moves relative to the display 102, or when the display 102 and the sensing devices 101 or 105 move relative to the user's head 103, the rendering of the 3D scene on the display 102 may be adjusted such that the change of the relative position between the user's head 103 and the display 102 is reflected in the rendering result, and the perception of the 3D scene by the user continues to be real and natural. In some embodiments, in addition to the relative position between the user's head 103 and the display 102, the size of the display 102 may also be taken into account for projecting the 3D objects 107 onto the display 102.

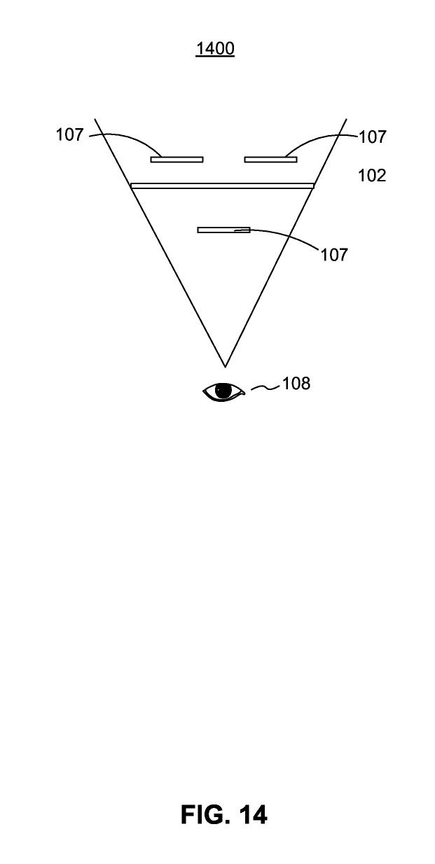

FIG. 14 illustrates an exemplary diagram 1400 of a perception of 3D objects in a virtual 3D space, in accordance with an embodiment of the present disclosure. The user perception of the 3D objects illustrated in FIG. 14 corresponds to the rendering result illustrated in FIG. 13, where the user's eye 108 is positioned in front of the center of the display 102. As shown in FIG. 14, the 3D objects 107 are placed in the virtual 3D space from the point of view of the user's eye 108. The 3D objects 107 in the virtual 3D space are located in front of the user's eye 108, reflecting the physical location of the user's head 103 relative to the display 102 illustrated in FIG. 13. As the relative position between the user's head 103 and the display 102 changes, the rendering of the 3D objects on the display may be adjusted, and the user perception of the 3D objects 107 in the virtual 3D space may change accordingly.

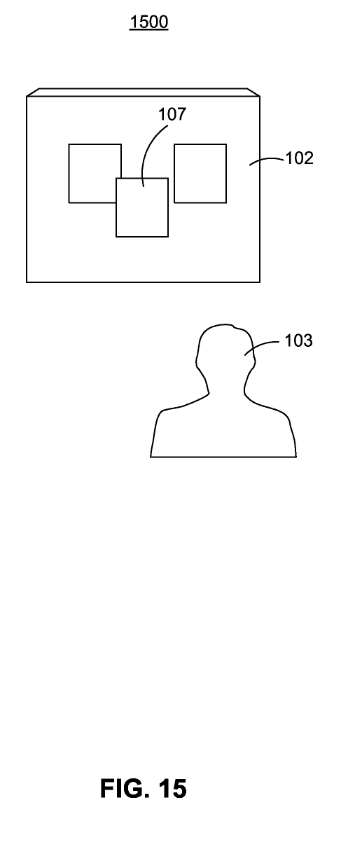

FIG. 15 illustrates another exemplary diagram 1500 of a rendering result, in accordance with an embodiment of the present disclosure. As shown in FIG. 15, the user's head 103 is moved to the right end of the display 102, and correspondingly, the rendering result of the 3D objects 107 on the display 102 may be adjusted responsive to the change of the user's eye position.

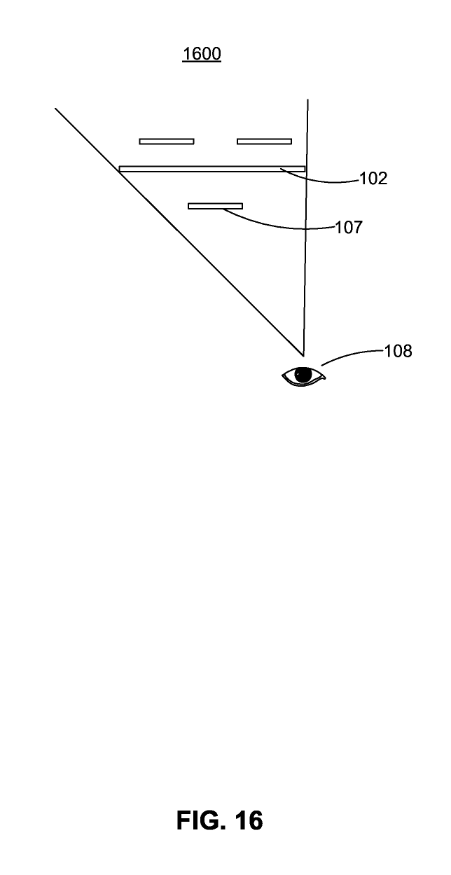

FIG. 16 illustrates another exemplary diagram 1600 of a perception of 3D objects in a virtual 3D space, in accordance with an embodiment of the present disclosure. The user perception of the 3D objects illustrated in FIG. 16 corresponds to the rendering result illustrated in FIG. 15, where the user's eye 108 is moved to the right end of the display 102. As shown in FIG. 16, the position of the 3D objects 107 in the virtual 3D space changes from the point of view of the user's eye 108, as the user moves from the center to the right end of the display. In response to the updated position of the user's head 103, the 3D objects 107 move to the left side of the user in the virtual 3D space, providing a realistic perception of the 3D scene that suits the user's point of view.

As described above, the gestures of a user's head and hand may be captured by the sensing device 101 and detected by the computer 115. The computer 115 may convert the detected user gestures into coordinates in the coordinate system R_{w} associate with the virtual 3D space. In some embodiments, the detected user gestures may then be used to control and interact with the 3D objects in the virtual 3D space perceived by the user.

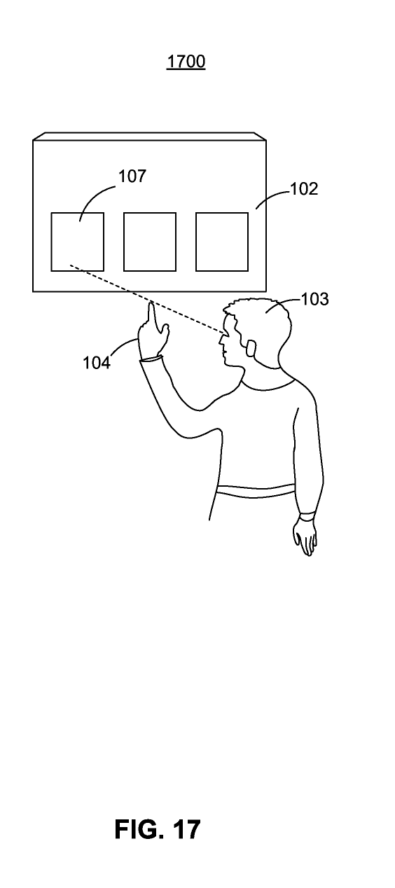

FIG. 17 illustrates an exemplary diagram 1700 of a user interaction with a 3D object rendered on a display, in accordance with an embodiment of the present disclosure. As shown in FIG. 17, the 3D object 107, a user interface element, is rendered on the display 102 based on the position of the user's head 103. To select the 3D object 107 rendered on the display 102, the user may place his finger at any point on the line connecting the user's head 103 to the position of the 3D object 107 in the virtual 3D space the user perceives.

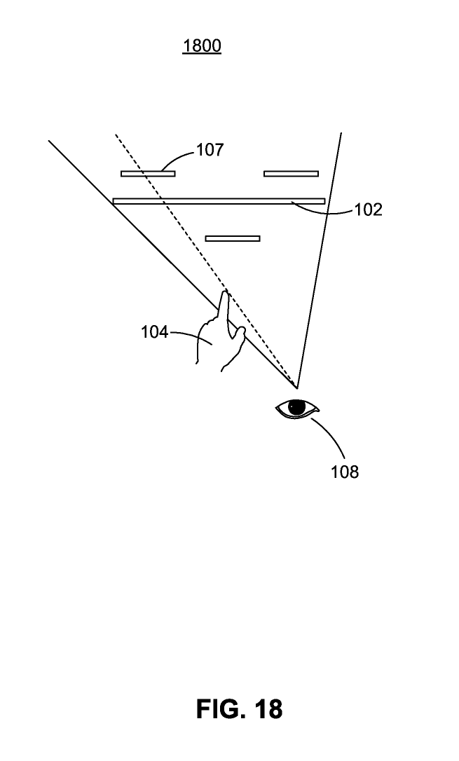

FIG. 18 illustrates an exemplary diagram 1800 of a user interaction with a 3D object in a virtual 3D space, in accordance with an embodiment of the present disclosure. In this diagram, the user interaction with the 3D object described in FIG. 17 is illustrated from the perspective of the user's view in the virtual 3D space. As shown in FIG. 18, a straight line may be formed between the position of the user's eye 108 and the position of the user's finger, and if the straight line intersects with a 3D object in the virtual space the user perceives, such as 3D object 107, the 3D object may be selected by the user. Thus, the 3D object may be remotely selected by the user based on the perceived position of the 3D object in the virtual 3D space and the user's head and hand positions. In this embodiment, the gesture of the user's finger may be made in the air without contacting the display 102 or the perceived 3D object in the virtual 3D space for a selection of the 3D object. In some embodiments, the computer 115 may determine a duration that the user's finger stays at the position for selecting the 3D object. If the duration that the user's finger stays at the position for selecting the 3D object is less than a predetermined time period, the computer 115 may determine that the 3D object is not selected. If the duration that the user's finger stays at the position for selecting the 3D object is greater than or equal to the predetermined time period, the computer 115 may determine that the 3D object is selected.

In other embodiments, a direct interaction with the 3D object in the virtual 3D space may be required to select the 3D object. For example, the user's hand or finger may need to be placed at a position overlapping with the 3D object in the virtual 3D space to perform a selection of the 3D object. In other words, when the user's hand or finger virtually touches the 3D object in the virtual 3D space, the 3D object may be selected. The direct interaction method may be combined with the remote selection method described in connection with FIGS. 17 and 18 for selection of user interface elements. For example, in a 3D scene containing multiple 3D objects, certain 3D objects may be selectable by the remote selection method while other 3D objects may require a direct interaction in order to be selected.

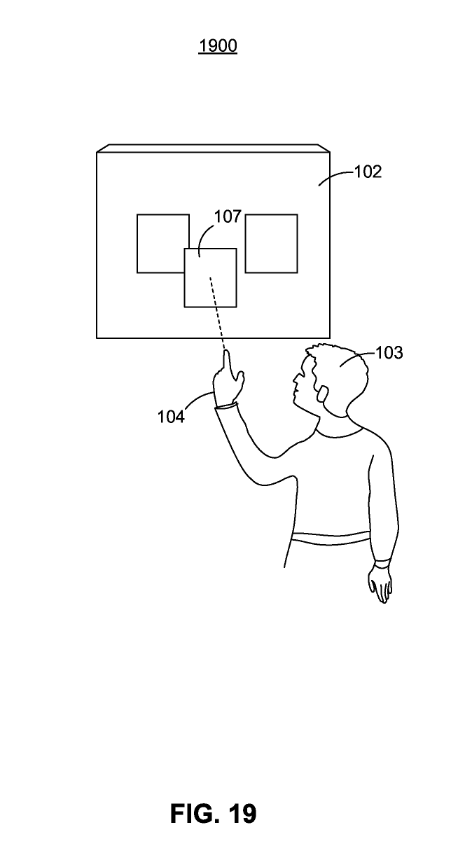

FIG. 19 illustrates another exemplary diagram 1900 of a user interaction with a 3D object rendered on a display, in accordance with an embodiment of the present disclosure. As shown in FIG. 19, the 3D object 107, a user interface element, is rendered on the display 102. To select the 3D object 107 rendered on the display 102, the user may point his finger in a direction towards the 3D object 107 in the virtual 3D space the user perceives. When the user points one of his fingers towards the position of the 3D object 107 in the virtual 3D space the user perceives, the 3D object 107 may be selected.

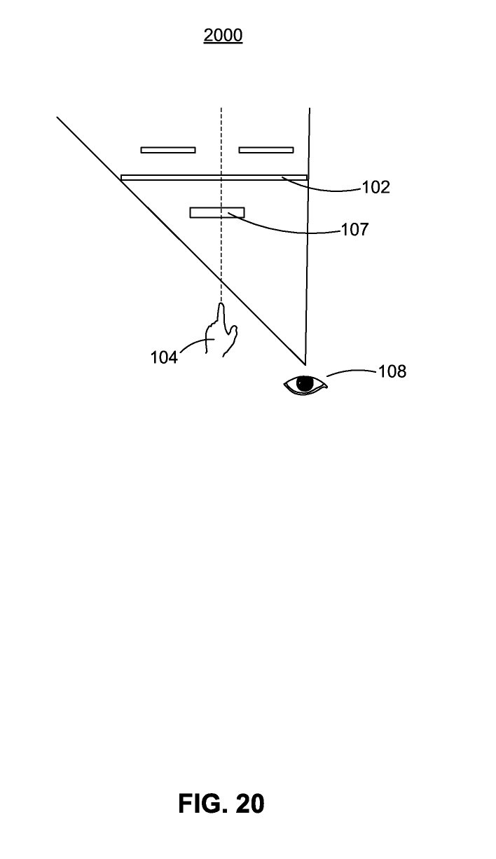

FIG. 20 illustrates another exemplary diagram 2000 of a user interaction with a 3D object in a virtual 3D space, in accordance with an embodiment of the present disclosure. In this diagram, the user interaction with the 3D object described in FIG. 19 is illustrated from the perspective of the user's view in the virtual 3D space. As shown in FIG. 20, when the user's finger points to the position of the 3D object 107 in the virtual 3D space, the 3D object 107 may be selected by the user. In doing so, the user may avoid place his hand or finger between the user's head and the position of the 3D object 107, which may result in a block of the user's view. This embodiment may be combined with other user interaction methods described above for selection of user interface elements. Further, a user may pre-configure one or more preferred user interaction methods for selecting a 3D object, such as one of the user interaction methods described in the present disclosure.

In some embodiments, when a selection of a 3D object is detected based on the user gestures captured by the sensing device, the interaction system may adjust the rendering of the 3D object to provide a realistic sensation to the user in the virtual 3D space.

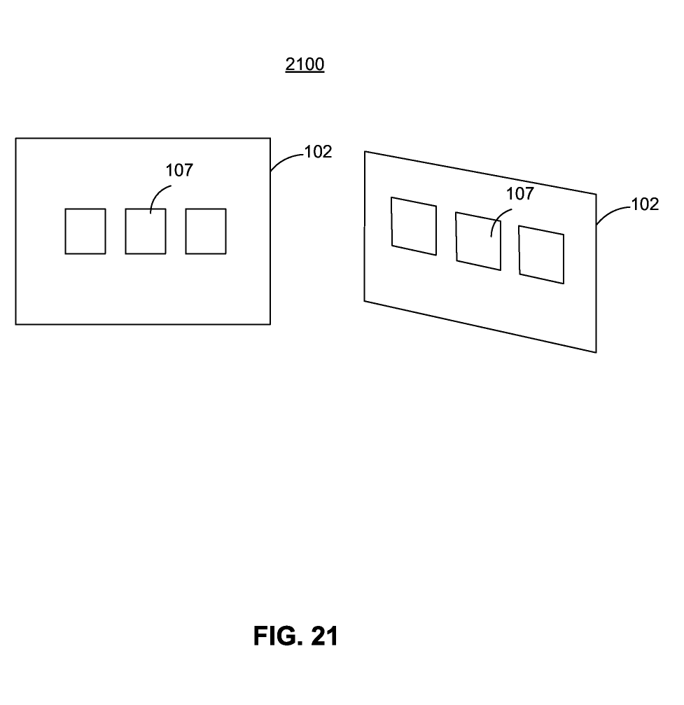

FIG. 21 illustrates an exemplary diagram 2100 of 3D objects rendered in a display and in a virtual 3D space respectively, in accordance with an embodiment of the present disclosure. The left side diagram shows 3D objects 107 rendered on the display 102 before a user selection is detected, for example, before a detection of one of the user interaction gestures described above in connection with FIGS. 17-20. The right side diagram shows the 3D objects 107 perceived by the user in the virtual 3D space before a user selection is detected, and as shown in FIG. 21, the 3D objects 107 are perceived to have the same depth as that of the display 102 in the virtual 3D space in this example.

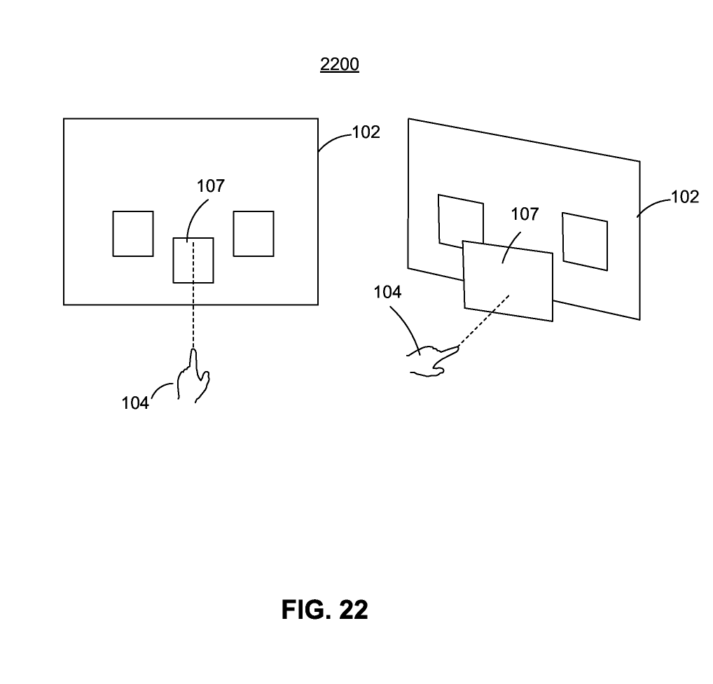

FIG. 22 illustrates another exemplary diagram 2200 of 3D objects rendered in a display and in a virtual 3D space respectively, in accordance with an embodiment of the present disclosure. Here, a user gesture for selecting one of the 3D objects 107 is detected. For example, the computer 115 may detect that the user's finger is pointing to direction of the middle 3D object based on the captured image of the user's hand. In response to the detected selection of a 3D object, the computer 115 may adjust rendering of the selected 3D object such that the selected 3D object appears to be zoomed in and popping out of the display 202 in the virtual 3D space. The left side diagram shows 3D objects 107 rendered on the display 102 when a user selection of the middle 3D object detected. The right side diagram shows the 3D objects 107 perceived by the user in the virtual 3D space when a user selection of the middle 3D object detected. It can be seen that the selected 3D object is zoomed in and moves out of the display 102 in a direction towards the user in the virtual 3D space, while the other unselected 3D objects remain at the same position. In some embodiments, upon detection of a selection of a 3D object, the rendering of the unselected 3D objects may also be adjusted to produce a visual effect of contrast to the selected 3D object. For example, the unselected 3D objects may be zoomed out or move in a direction away from the user in the virtual 3D space.

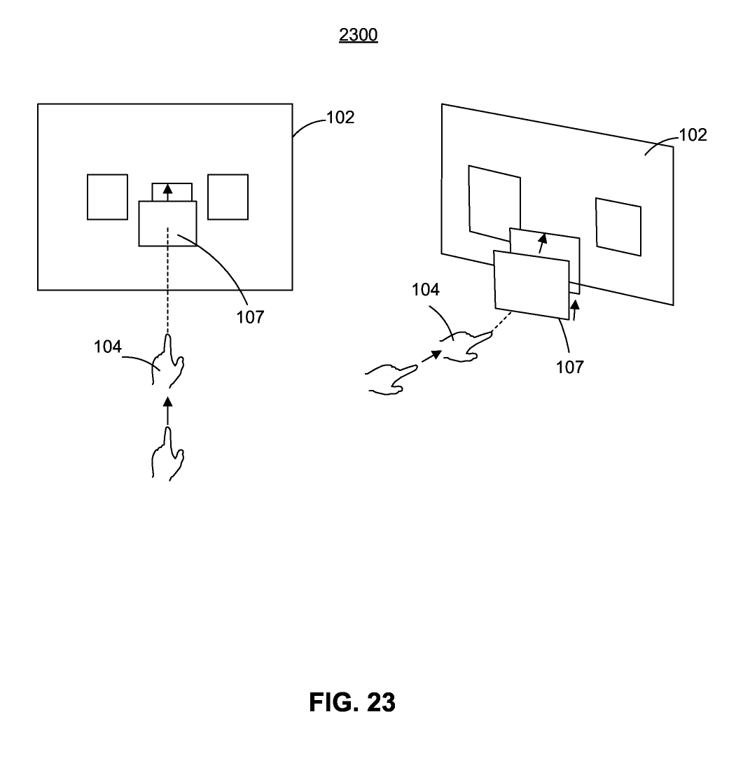

FIG. 23 illustrates another exemplary diagram 2300 of 3D objects rendered in a display and in a virtual 3D space respectively, in accordance with an embodiment of the present disclosure. As shown in FIG. 23, after initial selection of a 3D object, the user's finger keeps moving forward towards the position of the selected 3D object in the virtual 3D space, performing a push action on the selected 3D object in the virtual 3D space. The left side diagram shows that the selected 3D object 107 rendered on the display 102 is zoomed out when a user performs a push action on the selected 3D object in the virtual 3D space. The right side diagram shows that the selected 3D object is zoomed out and moves in a direction towards the display in the virtual 3D space when a user performs a push action on the selected 3D object. If the selected 3D object is caused to move a distance exceeding a predetermined distance threshold, the interactive system may determine that the selected 3D object is activated and cause an action associated with the selected 3D object to be performed. For example, the interactive system may open and display a file associated with the selected 3D object, turn on or turn off a component in the interactive system associated with the selected 3D object, or perform other actions, upon a detected activation of the selected 3D object.

In some embodiments, the moving speed of the selected 3D object in the virtual 3D space may be set based on the moving speed of the user's finger in the push action. For example, the faster the user's finger moves, the faster the selected 3D object may move towards the display in the virtual 3D space. In some implementations, the selected 3D object may be configured with an internal bouncing force that causes it to move in a direction towards the user. For example, when the user's finger moves at a reduced speed or stops moving, the internal bouncing force may cause the selected 3D object to pop out of the display towards the user in the virtual 3D space. Thus, the internal bouncing force counter balances the user's finger pushing force, providing the user a realistic sensation of a push button.

In some embodiments, the moving speed of the selected 3D object in the virtual 3D space may be set to be proportional to the difference between the force of the inward motion of the user's finger in the push action and the internal bouncing force of the selected 3D object. For example, the force of the inward motion may be determined to be greater if the user's finger moves faster, and consequently, the selected 3D object may move towards the display in the virtual 3D space at a faster speed.

The internal bouncing force may be set as a constant value that stays the same regardless of the stage of the movement of the selected 3D object. The internal bouncing force may be set to vary based on the stage of the movement of the selected 3D object, such as the moving distance of the selected 3D object relative to its initial position in the virtual 3D space. For example, the internal bouncing force of the selected 3D object may increase along with its continued movement towards the direction of the display.

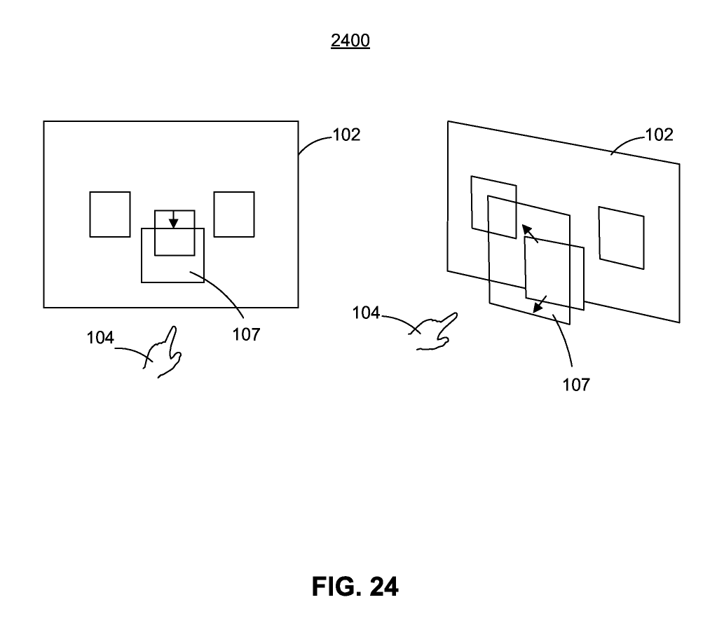

FIG. 24 illustrates another exemplary diagram 2400 of 3D objects rendered in a display and in a virtual 3D space respectively, in accordance with an embodiment of the present disclosure. Here, the user's finger stops moving, and the internal bouncing force of the selected 3D object causes the selected 3D object to move in a direction towards the user. The left side diagram shows that the selected 3D object 107 is zoomed in on the display 102 when the user's finger stops moving. The right side diagram shows that the selected 3D object is zoomed in and moves in a direction towards the user in the virtual 3D space when the user's finger stops moving as a result of the internal bouncing force.

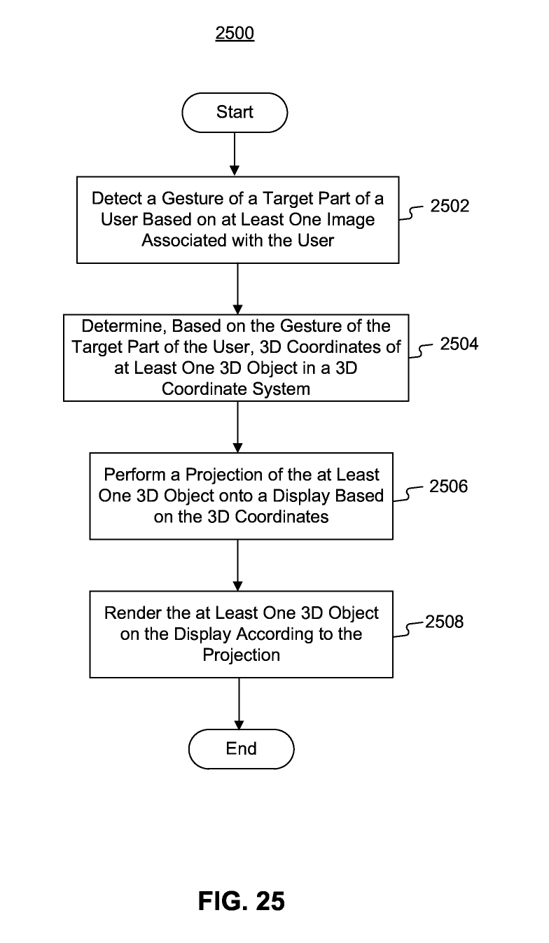

FIG. 25 is a flowchart of an exemplary method 2500 for providing a graphical user interface, in accordance with an embodiment of the present disclosure. The method 2500 may be performed by an interactive system, such as the interactive system 100 described in FIG. 1.

At step 2502, the interactive system detects a gesture of a target part of a user based on at least one image associated with the user. The image may be captured by a sensing device included in the interactive system. The gesture of the target part of the user is performed in the air without physical contact with the components of the interactive system. The target part of the user may include a head of the user, a hand of the user, one or more fingers of the user, or the like.

At step 2504, the interactive system determines, based on the gesture of the target part of the user, 3D coordinates of at least one 3D object in a 3D coordinate system. The 3D coordinate system may be associated with a virtual 3D space perceived by the user. In some embodiments, the interactive system may detect a 3D position and a 3D orientation of the target part of the user in a 3D coordinate system associated with the imaging sensor, and convert the 3D position and the 3D orientation to a corresponding 3D position and a corresponding 3D orientation in the 3D coordinate system associated with the virtual 3D space.

At step 2506, the interactive system performs a projection of the at least one 3D object onto a display based on the 3D coordinates of the at least one 3D object in the 3D coordinate system. For example, the interactive system may determine a displaying position and a displaying property of the 3D object based on the desired perception of the 3D object in the virtual 3D space.

At step 2508, the interactive system renders the at least one 3D object on the display according to the projection. From the user's point of view, the 3D object is presented with a depth in the virtual 3D space. Thus, the interactive system may provide a graphical user interface that tracks the gesture of the user and presents the 3D object correspondingly in the virtual 3D space to suit the user's point of view.

In exemplary embodiments, there is further provided a non-transitory computer readable storage medium including instructions, such as the memory 113 including instructions executable by the CPU 112 in the computer 115, to perform the above-described methods. For example, the non-transitory computer-readable storage medium may be a read-only memory (ROM), a random access memory (RAM), a CD-ROM, a magnetic tape, a floppy disc, an optical data storage device, and the like.

The specification has described devices, methods, and systems for providing a graphical user interface. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments.

It is intended that the disclosure and examples be considered as exemplary only, with a true scope and spirit of disclosed embodiments being indicated by the following claims.

What is claimed is:

1. A system for providing a graphical user interface, comprising:
a display;
at least one imaging sensor configured to capture at least one image associated with a user;
one or more processors; and
a memory for storing instructions executable by the one or more processors, wherein the one or more processors are configured to:
detect a gesture of a target part of the user based on the at least one image;
determine, based on the gesture of the target part of the user, three-dimensional (3D) coordinates of at least one 3D object in a 3D coordinate system, the 3D coordinate system being associated with a virtual 3D space perceived by the user;
perform a projection of the at least one 3D object onto the display based on the 3D coordinates; and
render the at least one 3D object on the display according to the projection.

2. The system of claim 1, wherein the one or more processors are further configured to determine, based on the gesture of the target part of the user, a selection of the at least one 3D object.

3. The system of claim 2, wherein the target part of the user comprises a head of the user and a finger of the user, and the gesture of the target part of the user is the finger of the user intersecting a straight line connecting a position of the head of the user to a position of the at least one 3D object in the virtual 3D space perceived by the user.

4. The system of claim 2, wherein the target part of the user comprises a finger of the user, and the gesture of the target part of the user is the finger of the user reaching at least a portion of a position of the at least one 3D object in the virtual 3D space perceived by the user.

5. The system of claim 2, wherein the target part of the user comprises a finger of the user, and the gesture of the target part of the user is the finger of the user pointing to a position of the at least one 3D object in the virtual 3D space perceived by the user.

6. The system of claim 2, wherein the one or more processors are further configured to, responsive to the selection of the at least one 3D object, cause the at least one 3D object to zoom in the virtual 3D space perceived by the user.

7. The system of claim 2, wherein the one or more processors are further configured to:
detect, based on a plurality of images captured by the at least one imaging sensor, a motion of the target part of the user in a direction towards the display; and
render the at least one 3D object on the display based on the detected motion.

8. The system of claim 7, wherein the one or more processors are further configured to detect a force of the motion and determine a speed of a movement of the at least one 3D object in the 3D coordinate system based on the force of the motion.

9. The system of claim 7, wherein the one or more processors are further configured to detect a reduced speed of the motion and cause the at least one 3D object to move in a direction towards the user in the 3D coordinate system.

10. The system of claim 7, wherein the one or more processors are further configured to perform at least one action associated with the at least one 3D object if a moving distance of the motion exceeds a predetermined threshold.

11. The system of claim 1, wherein the at least one imaging sensor is located on a top of the display or on a surface of a tabletop, the tabletop being used for placing the display.

12. The system of claim 1, wherein the at least one imaging sensor comprises a plurality of imaging sensors, each of the plurality of imaging sensors configured to capture at least one image associated with at least a portion of the target part of the user.

13. The system of claim 1, wherein detecting the gesture of the target part of the user comprises detecting a 3D position of the target part of the user and a 3D orientation of the target part of the user, the 3D position and the 3D orientation being defined in a 3D coordinate system associated with the at least one imaging sensor.

14. The system of claim 13, wherein the target part of the user comprises one or more fingers of the user, and wherein the one or more processors are configured to detect a 3D position and a 3D orientation of each of the one or more fingers of the user in the 3D coordinate system associated with the at least one imaging sensor.

15. The system of claim 13, wherein the one or more processors are further configured to:
convert the 3D position and the 3D orientation of the target part of the user in the 3D coordinate system associated with the at least one imaging sensor to a corresponding 3D position and a corresponding 3D orientation in the 3D coordinate system associated with the virtual 3D space, according to a relation between the 3D coordinate system associated with the virtual 3D space and the 3D coordinate system associated with the at least one imaging sensor.

16. The system of claim 1, wherein one or more processors are further configured to detect a position of at least one eye of the user based on the at least one image, and wherein the projection of the at least one 3D object is performed based on the 3D coordinates and the position of the at least one eye.

17. The system of claim 1, wherein the gesture of the target part of the user is performed in air, and the target part of the user comprises at least one of:
a head of the user;
a hand of the user; and
one or more fingers of the user.

18. The system of claim 1, wherein the display comprises a two-dimensional (2D) display device.

19. A method for providing a graphical user interface, comprising:
detecting a gesture of a target part of a user based on at least one image associated with the user;
determining, based on the gesture of the target part of the user, three-dimensional (3D) coordinates of at least one 3D object in a 3D coordinate system, the 3D coordinate system being associated with a virtual 3D space perceived by the user;
performing a projection of the at least one 3D object onto a display based on the 3D coordinates; and
rendering the at least one 3D object on the display according to the projection.

20. A non-transitory computer-readable storage medium storing program instructions executable by one or more processors to perform a method for providing a graphical user interface, the method comprising:
detecting a gesture of a target part of a user based on at least one image associated with the user;
determining, based on the gesture of the target part of the user, three-dimensional (3D) coordinates of at least one 3D object in a 3D coordinate system, the 3D coordinate system being associated with a virtual 3D space perceived by the user;
performing a projection of the at least one 3D object onto a display based on the 3D coordinates; and
rendering the at least one 3D object on the display according to the projection.
